(19) United States
(12) Patent Application Publication
(10) Pub. No.: US 2003/0046918 A1
(43) Pub. Date: Mar. 13, 2003

(54) Rock rake

(76) Inventor: Marc Roy SR., Middleboro, MA (US)

Correspondence Address: BROMBERG & SUNSTEIN LLP, 125 SUMMER STREET, BOSTON, MA, 02110-1618, US

(21) Appl. No.: 09/951,005

(22) Filed: Sep. 12, 2001

(51) Int. Cl. A01D 7/00; A01D 33/04

(52) U.S. Cl. 56/400.01; 171/144

(57) ABSTRACT

A rock rake includes a succession of elongated strips. The strips may be arranged as nested bands. Each successive band has a perimeter which is larger than the previous band. The bands have an inner surface for pushing objects along the ground. A base member is attached to the nested bands. The base member includes a pole or handle or supports a pole or handle for guiding the rake. A picking member may also be attached to the base member to dislodge embedded rocks from the ground during use of the rake.

### TECHNICAL FIELD

The present invention relates in general to lawn rakes and, in particular, to a rake for dislodging and capturing rocks from the ground.

### BACKGROUND ART

Conventional garden rakes typically have long narrow strips made of metal (or plastic reinforced with metal) called tines, which extend outward from one end of a triangularly shaped base member. The other end of the base member includes an attached pole for dragging the tines along the ground. The tines on conventional rakes scratch or dig into the ground during use.

### SUMMARY OF THE INVENTION

The present invention is directed to a rock rake. The rake includes several nested bands attached at a common point on a base member. Each successive band attached to the base member may have a perimeter larger than the previous band. The bands may have an inner surface for pushing objects along the ground. The bands may also form continuous rings, with the flat surface of each band vertically aligned with the ground during use of the rake. Rocks are pushed by the nested bands when the base member is pulled across the ground. The base member may be a pole or handle. Alternatively, the base member may include a threaded chamber for receiving and securing a pole or handle to guide the bands across the ground. A picking member may be attached to the base member to dislodge embedded rocks from the ground during use of the rake.

In another aspect of the invention, the rock rake includes a plurality of strips connected to a base member. Each strip has an elongated horizontal face for pushing objects along the ground. The strips may be bands attached at a common point to the base member.

A method for clearing rocks from an area of ground includes pulling a plurality of nested bands of increasing perimeter across the ground causing rocks to be pushed along by the bands. The method may also include digging a picking member into the ground to dislodge embedded rocks. The picking member may be attached to a base member. The method may further include holding a pole screwed into the base member while digging the picking member and pulling the nested bands.

### BRIEF DESCRIPTION OF THE DRAWINGS

The foregoing features of the invention will be more readily understood by reference to the following detailed description, taken with reference to the accompanying drawings, in which:

FIG. 1 is a perspective view of a rake according to one embodiment of the invention;

FIG. 2 is a perspective view of a base member illustrating a threaded chamber;

FIG. 3 is a perspective view of a flexible band shown separately from the base member;

FIG. 4 is a perspective view of the rake of FIG. 1 being used to rake rocks according to one embodiment of the invention.

### DETAILED DESCRIPTION OF SPECIFIC EMBODIMENTS

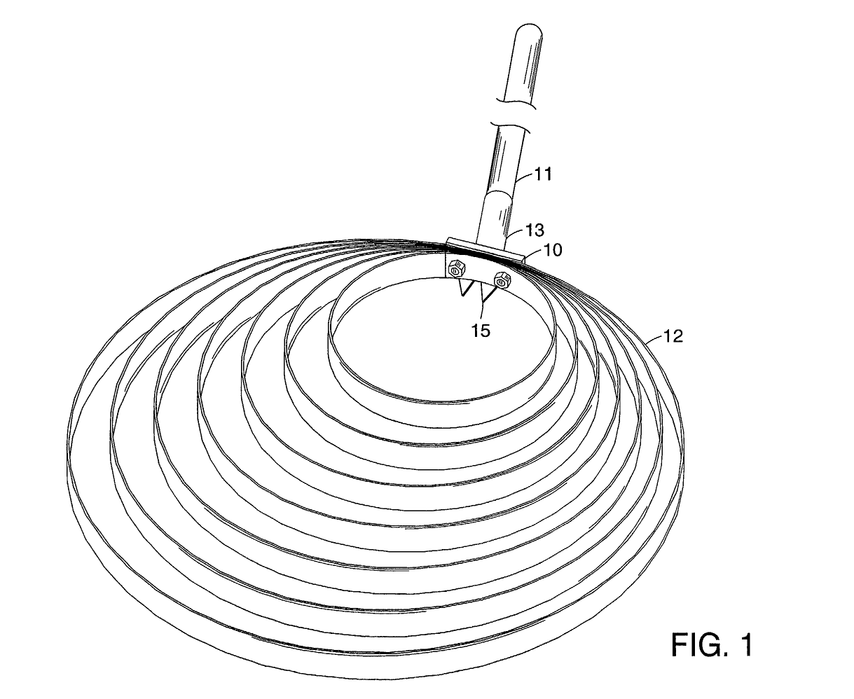

FIG. 1 shows a rake including a base member 10 having a chamber 13 for receiving a pole 11. It is further contemplated that the base member 10 may be itself a pole or other type of handle without the need for a chamber. As shown in FIG. 2, chamber 13 may be threaded so that one end of the pole 11 or handle may be easily attached and detached from the base member 10. In one embodiment, the chamber 13 may be fixed instead of threaded. Pole 11 is elongated and preferably has a cylindrical shape which conveniently fits the hands of a worker, although the pole 11 is not limited to this shape.

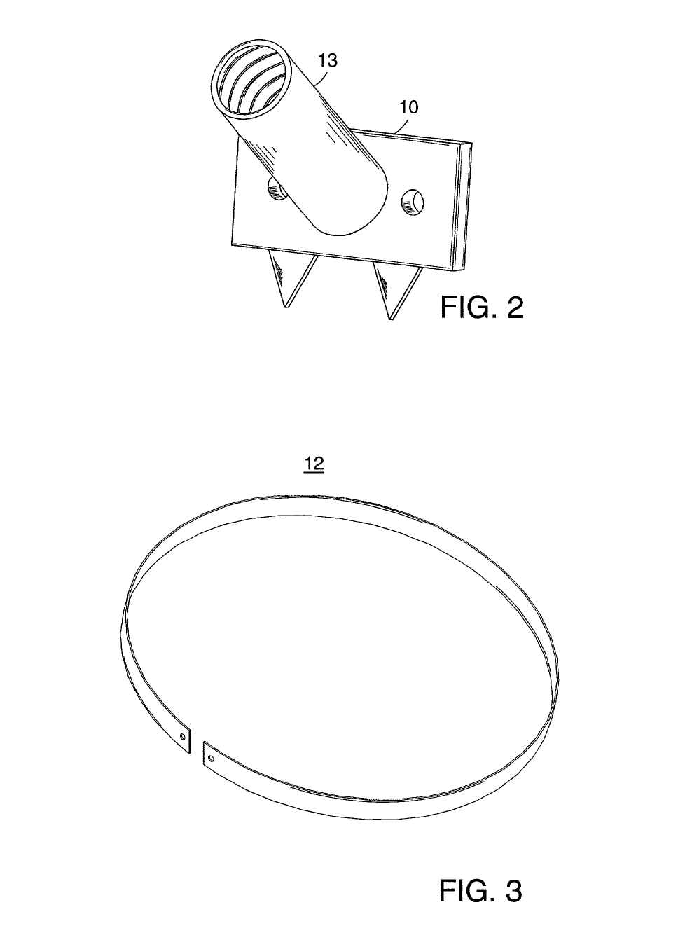

The raking portion is formed by a plurality of strips coupled to the base member. Each strip has a horizontally elongated face that rises up from a bottom edge. The strips form a succession of horizontally faces for pushing objects along the ground. In one embodiment, the strips are bands 12 attached in a nested configuration at a common point on the flat portion of base member 10. The flat portion of base member 12, in one embodiment, is 1¼″ high and about 2½″ long. As shown in FIG. 3, each band 12 may be a flat strip of a suitably stiff material, such as metal or plastic, which is curved into an elliptically shaped ring. As shown in FIG. 1, each band 12 extends outwardly from the base member 10, with each successive band having a slightly larger perimeter than the previous band. As can be seen in FIG. 1, the flat surface of each band 12 is oriented vertically so that the bottom edge of each band 12 is in contact with the ground. Bands 12 may be attached to base member 10 by inserting screws through pre-drilled holes in base member 10 (as shown in FIG. 2) and bands 12 (as shown in FIG. 3). In one embodiment, a hexagonal nut or the equivalent holds the screws in place. Of course other means of attachment, including but not limited to welding, riveting, bonding, and clamping may alternatively or additionally be used.

In another embodiment, a picking member 15 may be attached to the bottom of the base member 10 and extending down therefrom. Picking member 15 is preferably a rigid piece of metal such as steel, which may be formed into one or more “V” shapes. Of course, other shapes which make it convenient to dig embedded rocks out of the ground may also be used. Picking member 15 may be integral to the base member or attached to the bottom of base member 10 by welding or other suitable means. Picking member 15 may be used to dislodge embedded rocks by digging it into the ground prior to raking.

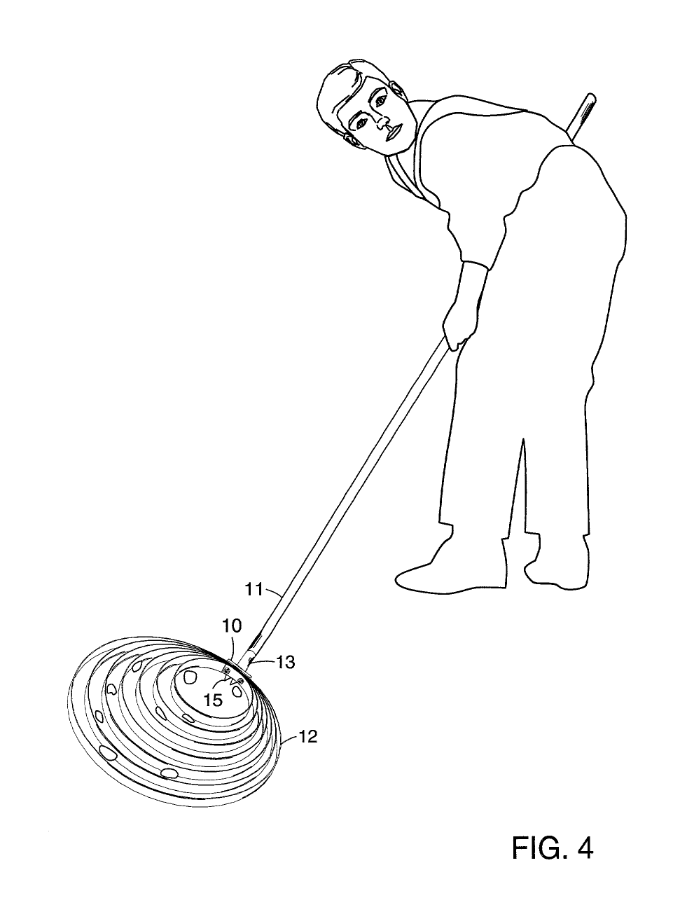

In the assembled configuration as shown in FIG. 4, the rake may be used by grasping the pole and pulling the bands 12 across the ground dragging it through matter such as rocks. In the course of pulling the rake, bands 12 push rocks along the ground. If a rock jumps out of a small perimeter band it may well get caught by a larger perimeter band. Rocks are advantageously moved along in the direction the rake is being pulled, while the bands safely glide over any grass. The trapped rocks may then be dragged to a convenient place for disposal. Prior to raking, picking member 15 may be used to dig into the ground to dislodge or loosen embedded rocks. This configuration of the rake also makes it convenient for other gardening activities, such as spreading mulch, without destroying plants or roots. Of course, the configuration of the rake, including the number and the height and thickness of the bands, may vary depending on the application of the rake. In one embodiment, the rake may be used to spread concrete. In another embodiment, the rake may be configured to be pulled behind a tractor, to clear a baseball infield of rocks, for example. In the aforementioned embodiments, the angle of the handle of the rake with respect to the ground may be varied depending on how the rake is to be used.

Although various exemplary embodiments of the invention have been disclosed, it should be apparent to those skilled in the art that various changes and modifications can be made which will achieve some of the advantages of the invention without departing from the true scope of the invention. These and other obvious modifications are intended to be covered by the appended claims

What is claimed is:

1. A rock rake comprising:
a base member; and
a plurality of nested bands attached to the base member.

2. The rock rake of claim 1, wherein the bands form rings of increasing perimeter.

3. The rock rake of claim 1, wherein each band has a flat surface, the flat surface being oriented vertically to the ground during use of the rake.

4. The rock rake of claim 1, wherein rocks are pushed by the nested bands when the base member is pulled across the ground.

5. The rock rake of claim 1, wherein the base member includes a chamber for receiving a pole.

6. The rock rake of claim 5, further comprising a pole, wherein the base member is secured to one end of the pole.

7. The rock rake of claim 1, wherein the base member comprises a handle.

8. The rock rake of claim 1, wherein the base member comprises a pole.

9. The rock rake of claim 1, further comprising a picking member for dislodging embedded rocks from the ground during use of the rake, wherein the picking member is attached to the base member.

10. The rock rake of claim 1, wherein the bands are attached at a common point to the base member.

11. A rock rake comprising:
a base member; and
a plurality of strips coupled to the base member, each strip having a bottom edge and a horizontally elongated face rising up from the bottom edge, the strips forming a succession of elongated faces for pushing objects along the ground.

12. The rock rake of claim 11, further comprising a picking member for dislodging embedded rocks from the ground during use of the rake, wherein the picking member is attached to the base member.

13. The rock rake of claim 11, wherein the base member includes a chamber for receiving a pole.

14. The rock rake of claim 11, wherein the base member comprises a handle.

15. The rock rake of claim 11, wherein the base member comprises a pole.

16. The rock rake of claim 11, wherein the strips comprise bands attached at a common point to the base member.

17. A method for clearing rocks from an area of ground comprising:
pulling a plurality of nested bands of increasing perimeter across the ground;
causing rocks to be pushed along by the bands.

18. The method of claim 17, wherein each band has a flat surface, the flat surface being oriented vertically to the ground.

19. The method of claim 17, further comprising digging a picking member into the ground to dislodge embedded rocks, wherein the picking member is coupled to the nested bands.

20. A method for clearing rocks from the ground comprising:
digging a picking member into the ground to dislodge embedded rocks, wherein the picking member is attached to a base member; and
pulling the base member to drag a plurality of nested bands across the ground, the bands urging the dislodged rocks along in the general direction the base member is being pulled.

21. The method of claim 20, wherein each of the bands has a flat surface, the flat surface being oriented vertically to the ground.

22. The method of claim 20, further comprising holding a pole coupled to the base member while digging the picking member and pulling the base member.

23. The method of claim 20, wherein the bands form rings of increasing perimeter.
